(19) United States
(12) Patent Application Publication
(10) Pub. No.: US 2026/0189686 A1
(43) Pub. Date: Jul. 2, 2026

(54) 3-DIMENSIONAL IMAGE DISPLAY DEVICE AND METHOD FOR DRIVING THE SAME

(71) Applicant: LG Display Co., Ltd., Seoul (KR)

(72) Inventors: Gyohyun KOO, Paju-si (KR); Hoon KANG, Paju-si (KR)

(73) Assignee: LG Display Co., Ltd., Seoul (KR)

(21) Appl. No.: 19/224,174

(22) Filed: May 30, 2025

(30) Foreign Application Priority Data
Dec. 30, 2024 (KR) 10-2024-0200114

(51) Int. Cl. H04N 13/366; H04N 13/122; H04N 13/305; H04N 13/317; H04N 13/327; H04N 13/398

(52) U.S. Cl. CPC H04N 13/366; H04N 13/122; H04N 13/317; H04N 13/327; H04N 13/398; H04N 13/305

(57) ABSTRACT

Embodiments relate to a display device and a method of driving the same. The display device in one or more examples includes an eye-tracking unit configured to capture a viewer image, a control unit configured to convert an externally input image signal into image data, identify a viewer's position relative to a display module based on the viewer image, and align and output the image data based on a view map corresponding to the viewer's position, a data driver configured to convert the image data output from the control unit into a data voltage and output the data voltage, and the display module configured to display a three-dimensional image based on the data voltage.

### CROSS-REFERENCE TO RELATED APPLICATION

The present application claims priority to Korean Patent Application No. 10-2024-0200114, filed in the Republic of Korea on Dec. 30, 2024, the entire contents of which is hereby expressly incorporated by reference into the present application.

### BACKGROUND

### Technical Field

The present disclosure relates to a three-dimensional image display device and a method for driving the same.

### Description of the Related Art

A three-dimensional display device that presents different images to the left and right eyes of a viewer can be classified into glasses-based and glasses-free types. The glasses-based method filters images using techniques such as polarization-based separation, time-division, or wavelength division based on the wavelengths of primary colors. The glasses-free method employs technologies like a parallax barrier or a lenticular lens to ensure that images are visible only from specific spatial positions.

The glasses-free approach can also include a light field method. A light field refers to the spatial or directional distribution of light rays emitted from an object. When a light field is optically reconstructed on an arbitrary plane, a user positioned behind that plane experiences a light ray distribution similar to that of a real object, allowing them to perceive a natural three-dimensional image. In other words, the light field method uses a display device to reproduce light rays emitted in multiple directions from points in space.

In a display device employing the light field method, the three-dimensional image appears clearest at specific positions determined by the designed optical system, with resolution decreasing when viewed outside these positions. Therefore, the user's position can be detected using a camera, enabling the light field display device to adjust and reconstruct the light field based on the user's location. Alternatively, the device can be designed to diversify the light field representation to achieve high resolution across various positions.

### SUMMARY OF THE DISCLOSURE

It is an object of the embodiments of the present disclosure to provide a three-dimensional image display device and a method for driving the same that are capable of correcting the alignment between a camera that detects a user's position and a display panel in a glasses-free three-dimensional image display device.

It is another object of the embodiments of the present disclosure to provide a three-dimensional image display device and a method for driving the same that are capable of determining alignment errors between a camera and a display panel by displaying a reference pattern on the display panel and capturing the reference pattern projected onto a reflective screen.

It is still another object of the embodiments of the present disclosure to provide a three-dimensional image display device and a method for driving the same that are capable of correcting the light field based on errors in the rotation, scale, and shift of the camera, which are determined from the reflected image of a reference pattern.

A display device according to an embodiment of the present disclosure can include an eye-tracking unit configured to capture a viewer image, a control unit configured to convert an externally input image signal into image data, identify a viewer's position relative to a display module based on the viewer image, and align and output the image data based on a view map corresponding to the viewer's position, a data driver configured to convert the image data output from the control unit into a data voltage and output the data voltage, and a display module configured to display a three-dimensional image based on the data voltage.

According to aspects of the present disclosure, the display module can include a display panel having a display area in which pixels are arranged and a non-display area surrounding the display area, and a lens array disposed on the display panel, the display module being configured to display a reference pattern in the non-display area to determine a misalignment between the eye-tracking unit and the display module.

According to aspects of the present disclosure, the display panel can include pixels disposed in the display area and configured to display the three-dimensional image, and dummy pixels disposed in the non-display area and configured to display the reference pattern.

According to aspects of the present disclosure, the display module can further include a light field film interposed between the display panel and the lens array, the light field film having the reference pattern formed at a position corresponding to the non-display area.

According to aspects of the present disclosure, the reference pattern can be a square or a rectangle shape.

According to aspects of the present disclosure, the eye-tracking unit can be configured to capture a reflected image by capturing a reflective screen disposed in front of the display module while the display module displays the reference pattern, the reflected image including a reflected image of the reference pattern.

According to aspects of the present disclosure, the control unit can include a compensation unit configured to determine whether a misalignment exists between the eye-tracking unit and the display module based on the reflected image of the reference pattern, calculate a compensation value to correct the misalignment, and correct and output the viewer image acquired from the eye-tracking unit based on the compensation value, and an image data generation unit configured to identify the viewer's position based on the corrected viewer image output from the compensation unit and align and output the image data based on a view map corresponding to the viewer's position.

According to aspects of the present disclosure, the control unit can further include a memory configured to store the compensation value.

According to aspects of the present disclosure, the compensation unit can be configured to calculate a shift compensation value to shift the reflected image to match a preset reference reflected image based on the reflected image being displaced in a horizontal or vertical direction relative to the preset reference reflected image.

According to aspects of the present disclosure, the compensation unit can be configured to calculate a rotation compensation value to rotate the reflected image to match the preset reference reflected image based on the reflected image being tilted relative to the preset reference reflected image.

According to aspects of the present disclosure, the compensation unit can be configured to calculate a scale compensation value to enlarge or reduce the reflected image to match the preset reference reflected image in size based on the reflected image differing in size from the preset reference reflected image.

According to aspects of the present disclosure, the display panel can include pixels disposed in the display area and configured to display the three-dimensional image, and dummy pixels disposed in the non-display area and configured to display the reference pattern, and the image data generation unit is configured to transmit image data to the dummy pixels to display the reference pattern.

According to aspects of the present disclosure, the eye-tracking unit can include a camera mounted on one side of the display module or within the display module.

A method of driving a three-dimensional image display device according to aspects of the present disclosure can include capturing, by a camera, a reflected image disposed in front of the display module through the camera while the display module displays the reference pattern, determining a misalignment between the camera and the display module based on a reflected image of the reference pattern included in the reflected image, calculating a compensation value to correct the misalignment, capturing a viewer image through the camera, correcting the viewer image based on the compensation value, identifying a viewer's position relative to the display module based on the corrected viewer image, and aligning and displaying image data of a three-dimensional image according to a predefined view map corresponding to the viewer's position.

According to aspects of the present disclosure, the display panel can include pixels disposed in the display area and configured to display the three-dimensional image, and dummy pixels disposed in the non-display area and configured to display the reference pattern, and the method can further include, prior to capturing the reflected image, controlling the dummy pixels to display the reference pattern.

According to aspects of the present disclosure, the display module can further include a light field film interposed between the display panel and the lens array, the light field film having the reference pattern formed at a position corresponding to the non-display area.

According to aspects of the present disclosure, the determining of the misalignment can include determining whether the reflected image matches a preset reference reflected image predefined for the reference pattern.

According to aspects of the present disclosure, the calculating of the compensation value can include calculating a shift compensation value to shift the reflected image to match a preset reference reflected image based on the reflected image being displaced in a horizontal or vertical direction relative to the preset reference reflected image, calculating a rotation compensation value to rotate the reflected image to match the preset reference reflected image based on the reflected image being tilted relative to the preset reference reflected image, and calculating a scale compensation value to enlarge or reduce the reflected image to match the preset reference reflected image in size based on the reflected image differing in size from the preset reference reflected image.

### BRIEF DESCRIPTION OF THE DRAWINGS

The present disclosure will become more fully understood from the detailed description given hereinbelow and the accompanying drawings which are given by way of illustration only, and thus are not limitative of the present disclosure.

FIG. 1 is a block diagram illustrating the configuration of a display device according to one or more embodiments of the present disclosure;

FIG. 2 is a perspective view of a display device according to an embodiment of the present disclosure;

FIG. 3 is an schematic exploded perspective view of a display module according to an embodiment of the present disclosure;

FIG. 4 is a diagram illustrating a view map according to an embodiment of the present disclosure;

FIG. 5 is a schematic diagram illustrating an image provided to a viewer according to the view map of FIG. 4;

FIG. 6 is a diagram illustrating a view map that changes according to various viewing positions;

FIG. 7 is a diagram illustrating issues caused by a misalignment between an eye-tracking unit and a display module;

FIG. 8 is a perspective view of a display device according to another embodiment of the present disclosure;

FIG. 9 is a schematic exploded perspective view of a display module according to another embodiment of the present disclosure;

FIG. 10 is a schematic exploded perspective view of a display module according to still another embodiment of the present disclosure;

FIG. 11 is a schematic cross-sectional view of a display device;

FIG. 12 is a block diagram illustrating the configuration of a control unit according to an embodiment of the present disclosure;

FIG. 13 is a diagram illustrating a method of correcting an image based on reflected images obtained through the eye-tracking unit; and

FIG. 14 is a flowchart illustrating a method for driving a display device according to an embodiment of the present disclosure.

### DETAILED DESCRIPTION OF THE EMBODIMENTS

Hereinafter, embodiments of the present disclosure will be described with reference to accompanying drawings. In the specification, when a component (or area, layer, part, etc.) is mentioned as being “on top of,” “connected to,” or “coupled to” another component, it means that it can be directly connected/coupled to the other component, or a third component can be placed between them.

The same reference numerals refer to the same components. In addition, in the drawings, the thickness, proportions, and dimensions of the components are exaggerated for effective description of the technical content. The expression “and/or” is taken to include one or more combinations that can be defined by associated components.

The terms “first,” “second,” etc. are used to describe various components, but the components should not be limited by these terms. The terms are used only for distinguishing one component from another component. For example, a first component can be referred to as a second component and, similarly, the second component can be referred to as the first component, without departing from the scope of the present disclosure. The singular forms are intended to include the plural forms as well unless the context clearly indicates otherwise.

The terms such as “below,” “lower,” “above,” “upper,” etc. are used to describe the relationship of components depicted in the drawings. The terms are relative concepts and are described based on the direction indicated on the drawings. Further, the term “can” fully encompasses all the meanings and coverages of the term “may.”

It will be further understood that the terms “comprises,” “has,” and the like are intended to specify the presence of stated features, numbers, steps, operations, components, parts, or a combination thereof but are not intended to preclude the presence or possibility of one or more other features, numbers, steps, operations, components, parts, or combinations thereof.

Now, various embodiments of the present disclosure will be discussed by referring to the drawings. All the components of each display device according to all embodiments of the present disclosure are operatively coupled and configured.

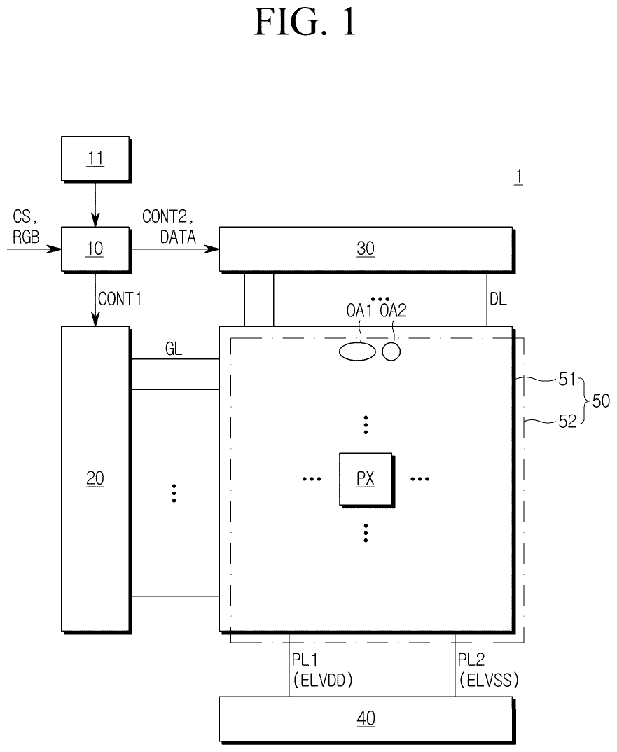

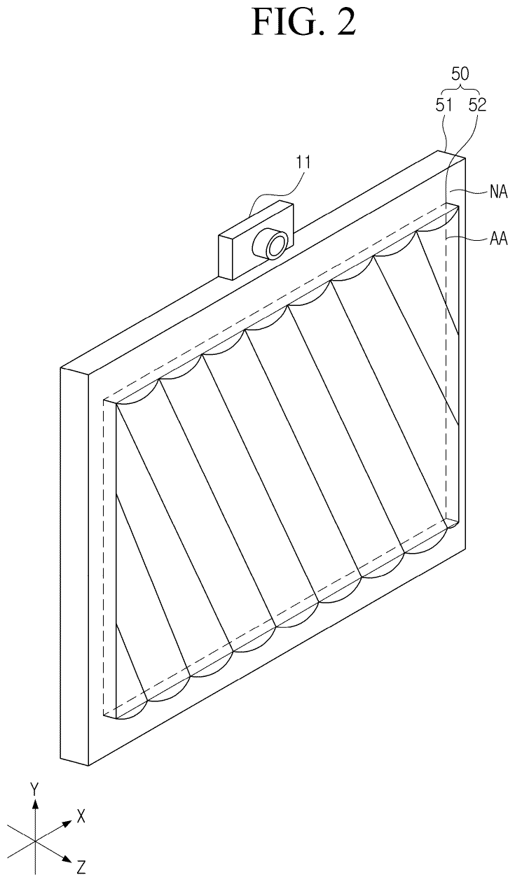

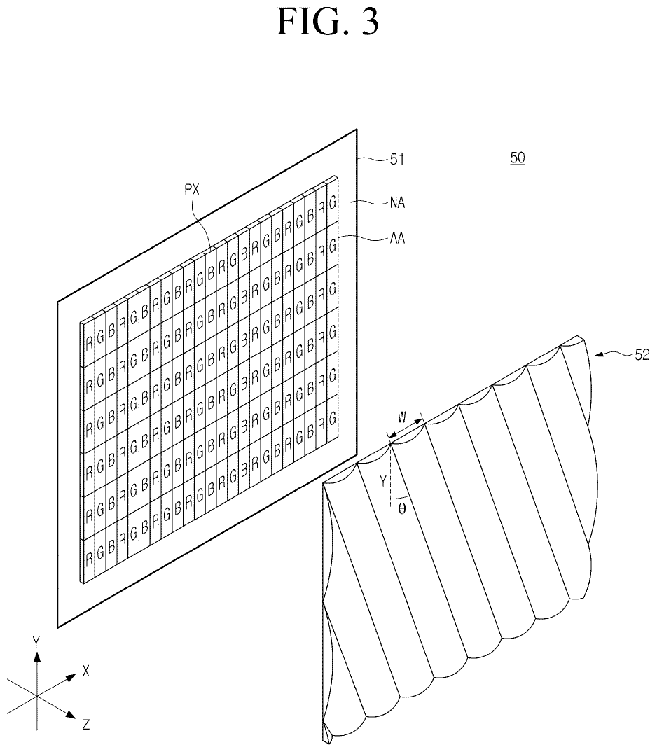

FIG. 1 is a block diagram illustrating a configuration of a display device according to one or more embodiments of the present disclosure. FIG. 2 is a perspective view of a display device according to an embodiment of the present disclosure. FIG. 3 is an schematic exploded perspective view of a display module according to an embodiment of the present disclosure.

Referring to FIG. 1, in some embodiments of the present disclosure, a display device 1 is a glasses-free three-dimensional image display device configured to utilize a light field method. The light field refers to a concept that represents the distribution of light in space through light rays. Each of a plurality of points on a specific plane in space can be defined by three-dimensional spatial coordinates (x, y, z). When light rays are emitted from an object, the light field display device records the spatial directional angles θ and φ, color, and intensity of the light rays passing through each point on a specific plane. By reproducing the recorded light field information through the display module 50, the light field display device provides a three-dimensional image of the object to the user.

The display device 1 can include an eye-tracking unit 11, a control unit 10, a gate driver 20, a data driver 30, a power supply unit 40, and a display module 50.

The eye-tracking unit 11 can detect the position of the user's eyes. The eye-tracking unit 11 can capture the user in real-time and transmit the captured image to the control unit 10. The eye-tracking unit 11 can include a web camera, monocular camera, stereo camera, multi-camera, and depth-sensing camera. When the eye-tracking unit 11 is configured as a camera, the camera can be attached or mounted to one side of the display module 50, as shown in FIG. 2.

The control unit 10 can control the overall operation of the display device 1. The control unit 10 can process video signals RGB obtained from an external host system or internal memory to generate image data DATA, and output the generated image data DATA to the data driver 30. The video signal RGB input to the control unit 10 can be a 2-dimensional (2D) or 3-dimensional (3D) image signal. The 3D image signal can be a hologram image, stereo image, light field image, integral photography (IP) image, multi-view, or super multi-view image. The control unit 10 can convert the 3D image signal according to a preset image conversion algorithm to generate left-eye and right-eye image data. In this case, the control unit 10 can output the left-eye and right-eye image data alternately.

The control unit 10 can calculate the positions of the user's left and right eyes from the image input from the eye-tracking unit 11. The control unit 10 can rearrange the left-eye and right-eye image data into a multi-view map in response to the detected positions of the eyes and output the rearranged image data.

The control unit 10 can generate additional drive control signals CONT1, CONT2, and CONT3 for controlling the operating units 20, 30, and 40 based on control signals provided externally, such as horizontal sync signals, vertical sync signals, and a main clock signal.

The gate driver 20 can generate scan signals and provide the generated scan signals to a plurality of scan lines GL through pixels PX based on the gate drive control signal CONT1 input from the control unit 10. In one embodiment of the present disclosure, a single pixel PX can be configured to receive multiple scan signals with different waveforms. In this embodiment of the present disclosure, the gate driver 20 can provide the multiple scan signals through the scan lines GL to the corresponding pixels PX in the pixel row.

The gate driver 20 can be configured in the form of a Gate In Panel mounted on the display panel 51. The gate driver 20 can be disposed on one side of the display panel 51 or, as shown in the drawing, on both sides (e.g., left and right) of the display panel 51. Depending on the driving method, panel design method, etc., the gate driver 20 can be disposed on both sides (e.g., left and right) of the display panel 51, as shown in the drawing, or can be connected to two or more of the four sides of the display panel 51.

The data driver 30 can generate data signals based on the image data DATA and data driving control signal CONT3 output from the timing controller 10. The data driver 30 can provide the generated data signals to the pixels PX through multiple data lines DL.

The power supply unit 40 can generate the high-potential driving voltage ELVDD and low-potential driving voltage ELVSS to be supplied to the display panel 51 based on the power supply control signal CONT4. The power supply unit 40 can provide the generated driving voltages ELVDD and ELVSS to the pixels PX through the corresponding voltage lines PL1 and PL2.

Referring to both FIGS. 1 and 3, the display module 50 can include a display panel 51 and a lens array 52.

The display panel 51 can be, for example, a liquid crystal display panel, organic light-emitting diode display panel, plasma display panel (PDP), electrophoretic display panel, quantum dot display panel, mini LED display panel, micro LED display panel, etc., but is not limited thereto.

The display panel 51 can include a display area AA (or active area) and a non-display area NA (or non-active area) arranged adjacent to the display area AA. The non-display area NA can contain driving units, such as the gate driver 20, and wiring components.

The display area AA can contain a plurality of pixels PX (or subpixels) arranged in a matrix form on the display panel 51. The pixels PX can be arranged, for example, in a matrix form on the display panel 51. The pixels PX arranged in a single pixel row can be connected to the same scan line GL and emission line EL, and the pixels PX arranged in a single pixel column can be connected to the same data line DL. The pixels PX can emit light with corresponding brightness based on the scan and data signals supplied through the scan line GL and data line DL.

In one embodiment of the present disclosure, each pixel PX can display one of the colors, red, green, or blue. In another embodiment of the present disclosure, each pixel PX can display one of the colors, cyan, magenta, or yellow. In various embodiments of the present disclosure, each pixel PX can display one of the colors, red, green, blue, or white.

In one embodiment of the present disclosure, the display panel 51 can include one or more optical areas OA1 and OA2. The one or more optical areas OA1 and OA2 can be arranged in overlap with one or more optoelectronic devices, such as imaging devices (e.g., cameras or image sensors), proximity sensors, or illuminance sensors. When the eye-tracking unit 11 is configured as a camera, the camera constituting the eye-tracking unit 11 can be placed in the optical areas OA1 and OA2.

For the operation of an optoelectronic device, one or more optical areas OA1 and OA2 can include a light-transmissive structure to achieve a transmittance above a certain level. The light-transmissive structure can be formed by patterning the cathode electrode in areas where pixels PX are not arranged. The cathode electrode can be patterned either by laser removal or by selective formation using a cathode deposition prevention layer.

Alternatively, the light-transmissive structure can be formed by separating the light-emitting elements within the pixel PX. In this embodiment of the present disclosure, the light-emitting element of the pixel PX is located in the optical areas OA1 and OA2, the plurality of transistors constituting the pixel PX are arranged around the optical areas OA1 and OA2, and the light-emitting element and the pixel can be electrically connected through a transparent metal layer.

The number of pixels PX per unit area in one or more optical areas OA1 and OA2 can be smaller than the number of pixels PX per unit area in the remaining area excluding the optical areas OA1 and OA2. That is, the resolution of the one or more optical areas OA1 and OA2 can be lower than the resolution of the remaining area.

The lens array 52 can be placed on the display panel 51. The lens array 52 can include a lenticular lens array, a micro lens array, or the like. The light emitted from the display panel 51 can form a light field directed in a specific direction (e.g., the user's viewing direction) by the lens array 52.

When the lens array 52 is a lenticular lens array, the lens array 52 can have a predetermined width w and can consist of lenticular lenses in a semicircular cylindrical shape extended in one direction. The lenticular lenses can be inclined by a predetermined angle θ based on the vertical direction Y) of the pixels (R, G, B). The inclined arrangement of the lenticular lenses can control the view map for 3D image viewing.

The arrangement of the pixels PX on the display panel 51 to form the light field, the arrangement of the lenticular lenses constituting the lens array 52, and the relative positional relationship between the pixels PX and the lenticular lenses are not limited to those illustrated.

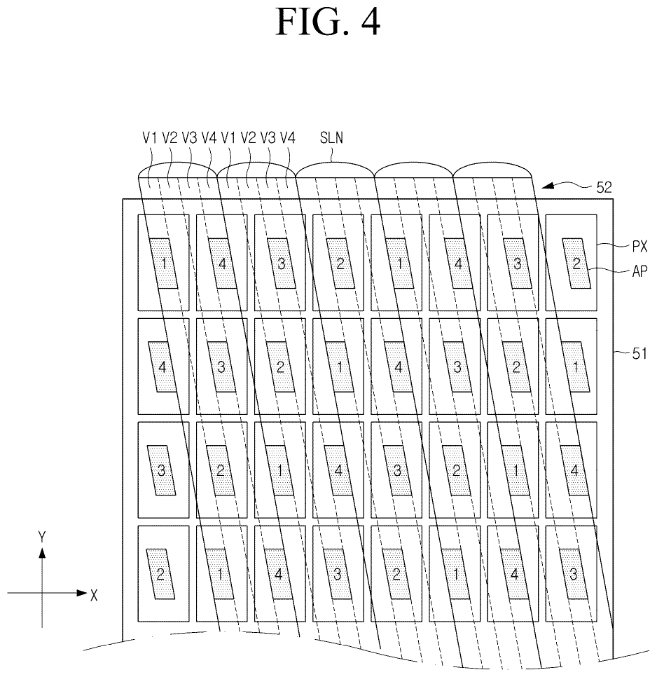

FIG. 4 is a diagram illustrating a view map according to an embodiment of the present disclosure.

Referring to FIG. 4, the display module 50 can include the display panel 51 and the lens array 52, which is placed on the upper surface of the display panel 51. The display panel 51 can include a plurality of pixels PX arranged in a matrix configuration. Each pixel PX can be assigned a single aperture AP. The aperture AP is an area that displays the color and brightness represented by the pixel PX. For example, it can be defined as an area representing one of the colors: red, green, or blue. The area excluding the aperture AP is covered by a black matrix.

The lens array 52 can include a plurality of lenticular lenses SLN in the shape of semicircular cylinders arranged consecutively. The lenticular lenses SLN can be attached to the upper surface of the display panel 51 with a constant tilt angle. Here, the tilt angle of the lenticular lens SLN can be set as a delta value calculated on a pixel unit basis. For example, in the case of a ⅓ delta structure, the tilt angle of the lenticular lens SLN can be equal to {the pixel's horizontal width/(3×the pixel's vertical length)}. Here, the delta value can be set as n/m, where n is a natural number and m is a natural number greater than n.

Each lenticular lens SLN can be configured to define k view areas V1, V2, V3, and V4. Each of the view areas V1, V2, V3, and V4 can have an inclined vertical strip shape with a predetermined width (view width), and the plurality of view areas V1, V2, V3, and V4 can be arranged consecutively in the horizontal direction. Each of the view areas V1, V2, V3, and V4 can be assigned apertures AP. Pixels PX assigned to the same view area V1, V2, V3, and V4 can display the same type of image (1, 2, 3, and 4). The setting of the view areas V1, V2, V3, and V4 can be determined by the design method.

In the illustrated embodiment of the present disclosure, for a single lenticular lens SLN, four view areas V1, V2, V3, and V4 can be defined. Pixels PX assigned to each view area V1, V2, V3, and V4 can display unique images. Thus, the display device 1 shown in FIG. 4 can simultaneously display four images (1, 2, 3, and 4) that can be viewed from four directions. In the illustrated embodiment of the present disclosure, the pixels PX arranged in the first view area V1 can display the first image (1), the pixels PX arranged in the second view area V2 can display the second image (2), the pixels PX arranged in the third view area V3 can display the third image (3), and the pixels PX arranged in the fourth view area V4 can display the fourth image (4).

For such image display, the images (1, 2, 3, and 4) can be displayed according to a view map arranged in the order 1-4-3-2 in each pixel row. Additionally, the images (1, 2, 3, and 4) can be displayed according to a view map arranged in the order 1-4-3-2 in each pixel column. This view map is a reference view map set such that the pixels PX distributed across the entire area of the display panel 51 provide the same type of image to the viewer located at the optimal viewing distance.

When the viewer is at the optimal viewing distance, among the four images (1, 2, 3, and 4), the image in direction 1 is provided to the left eye, and the image in direction 2 is provided to the right eye. As a result, the viewer can observe the 3D image. When the viewer moves horizontally in correspondence with the view width, unique images can be displayed for the left and right eyes, and normal 3D images can be observed. However, when the viewer moves horizontally by a distance not corresponding to the view width, or moves closer or farther than the optimal viewing distance, normal 3D images may not be observed.

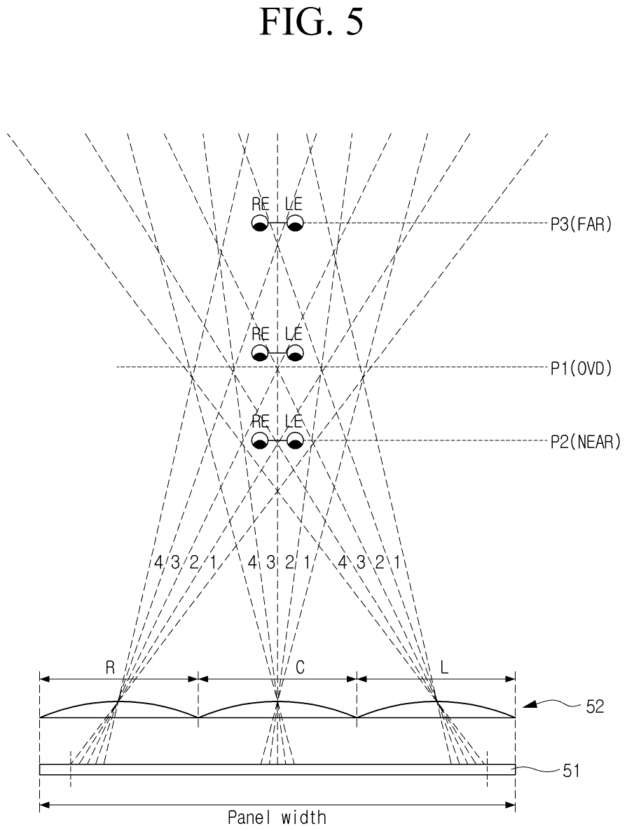

FIG. 5 is a schematic diagram illustrating an image provided to a viewer according to the view map of FIG. 4.

Referring to FIG. 5, when displaying images according to the same view map as in FIG. 4, at the optimal viewing distance (OVD), the first view area V1, second view area V2, third view area V3, and fourth view area V4 sequentially provide the first image, second image, third image, and fourth image (1-2-3-4).

When the viewer is positioned at the first viewing position P1, which is the optimal viewing distance OVD, the left eye LE receives the second image (2) and the right eye RE receives the third image (3) from the central area C, left area L, and right area R of the display panel 51. That is, at the optimal viewing distance OVD, the viewer receives the second image (2) in the left eye LE and the third image (3) in the right eye RE for all areas of the display panel 51, allowing for the normal observation of a 3D image.

When the viewer is positioned at the second viewing position P2, which is a closer viewing distance NEAR than the optimal viewing distance OVD, in the central area C of the display panel 51, the second image (2) is provided to the left eye LE and the third image (3) to the right eye RE. In the left area L of the display panel 51, the third image (3) is provided to the left eye LE and the fourth image (4) to the right eye RE. In the right area R of the display panel 51, the first image (1) is provided to the left eye LE and the second image (2) to the right eye RE. That is, at the closer viewing distance NEAR, different images are provided to the left and right eyes across all areas of the display panel 51, so normal 3D images may not be observed.

When the viewer is positioned at the third viewing position P3, which is a farther viewing distance FAR than the optimal viewing distance OVD, in the central area C of the display panel 51, the second image (2) is provided to the left eye LE and the third image (3) to the right eye RE. In the left area L of the display panel 51, the first image (1) is provided to the left eye LE and the second image (2) to the right eye RE. In the right area R of the display panel 51, the third image (3) is provided to the left eye LE and the fourth image 4 to the right eye RE. That is, at the farther viewing distance FAR, different images are provided to the left and right eyes across all areas of the display panel 51, so normal 3D images may not be observed.

When the viewer moves horizontally by a distance that does not correspond to the view width, two images (1, 2, 3, 4) displayed in two adjacent view areas V1, V2, V3, and V4 in the left eye LE and right eye RE can be visible, so correct 3D images may not be observed.

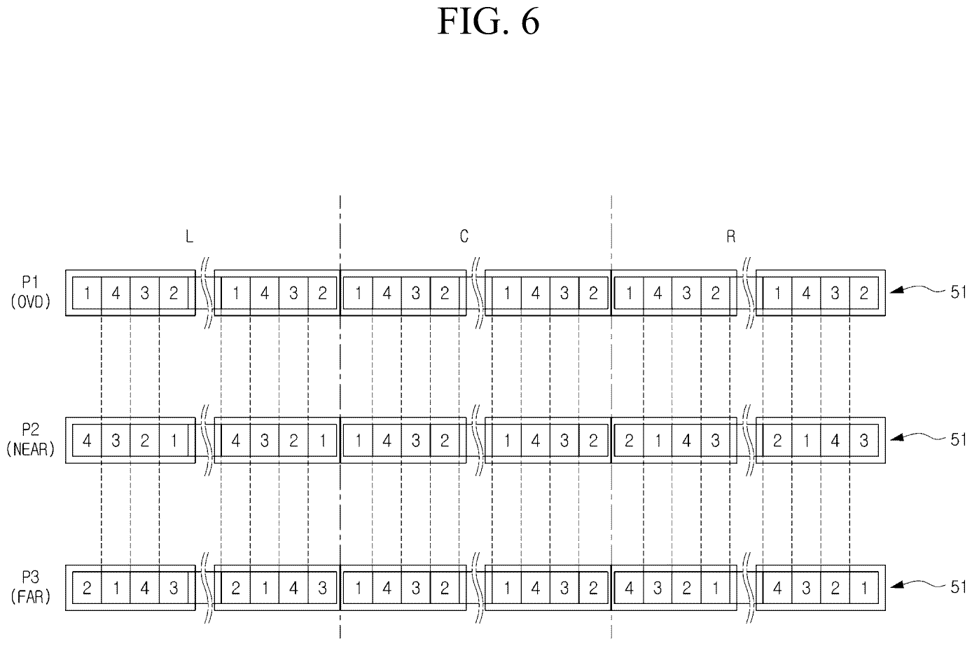

FIG. 6 is a diagram illustrating a view map that changes according to various viewing positions.

As described with reference to FIGS. 1 and 2, the display device 1 according to an embodiment of the present disclosure recognizes the viewer's position through the eye-tracking unit 11 and provides an adjusted view map to ensure that a correct 3D image can always be perceived. For example, when the viewer is positioned at the first position P1, which is the optimal viewing distance OVD, images are provided according to a reference view map arranged in the order of 1-4-3-2.

When the viewer is positioned at the second position P2, which is a near viewing distance NEAR, the reference view map is provided in the central area C, while a near-distance corrected view map is provided in the left area L and the right area R. For example, images are provided based on a near-distance view map arranged in the order of 4-3-2-1 in the left area L and in the order of 2-1-4-3 in the right area R.

Additionally, when the viewer is positioned at the third position P3, which is a far viewing distance FAR, the reference view map is provided in the central area C, whereas a near-distance corrected view map is provided in the left area L and the right area R. For example, images are provided based on a near-distance view map arranged in the order of 2-1-4-3 in the left area L and in the order of 4-3-2-1 in the right area R.

When the viewer moves horizontally by a distance that does not correspond to the view width, the luminance and/or grayscale of images 1, 2, 3, and 4 displayed in the adjacent view areas V1, V2, V3, and V4 can be interpolated to an intermediate value or the like for display. The degree of interpolation of the images can be determined in various ways based on factors such as the viewer's movement position and the luminance and/or grayscale differences between adjacent images.

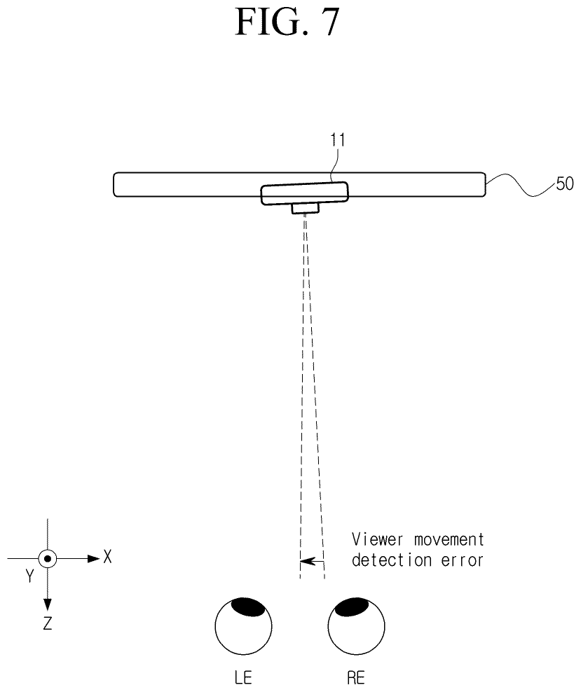

FIG. 7 is a diagram illustrating issues caused by a misalignment between an eye-tracking unit and a display module.

As described above, the eye-tracking unit 11, which includes a camera, captures the viewer positioned in front of the display in real time, detects the viewer's position through image processing, and adjusts the view map accordingly via the control unit 10. To dynamically control the view map based on the viewer's position, it is important to accurately detect the viewer's location. For this purpose, the camera constituting the eye-tracking unit 11 and the display module 50 must be properly aligned. For example, the camera can be placed on one side of the display module 50, e.g., the upper side, or embedded within the display module 50. In this case, to accurately detect the viewer's position, the camera must be aligned with the display module 50 at predefined positions in the vertical Y, horizontal X, and depth Z directions.

For example, one side of the camera (e.g., the lower side) and one side of the display module 50 (e.g., the upper side) must be aligned at a predefined distance in the vertical Y direction. Additionally, another side of the camera (e.g., the left side) and another side of the display module 50 (e.g., the left side) must be aligned at a predefined distance in the horizontal X direction. Furthermore, another side of the camera (e.g., the front side) and another side of the display module 50 (e.g., the front side) must be aligned at a predefined distance in the depth Z direction.

For example, the camera's shooting direction (front) should be oriented toward the front of the display module 50, and the shooting direction and the front of the display module 50 should generally be aligned or adjusted according to a preset rotation angle. Additionally, the camera itself must be properly leveled.

Referring to FIG. 7, when the camera constituting the eye-tracking unit 11 and the display module 50 are not properly aligned, the viewer's exact viewing position may not be determined, preventing the correct view map from being set, which can result in a reduced viewing angle and increased crosstalk between adjacent view images.

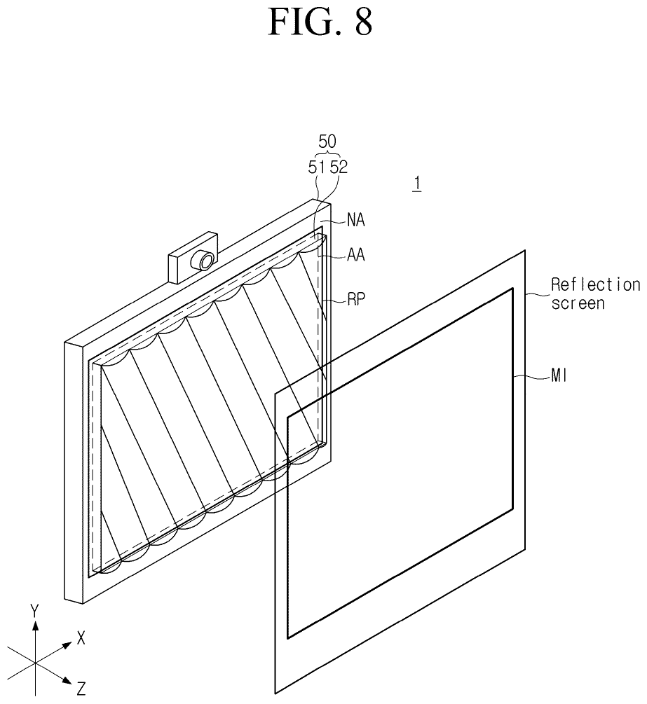

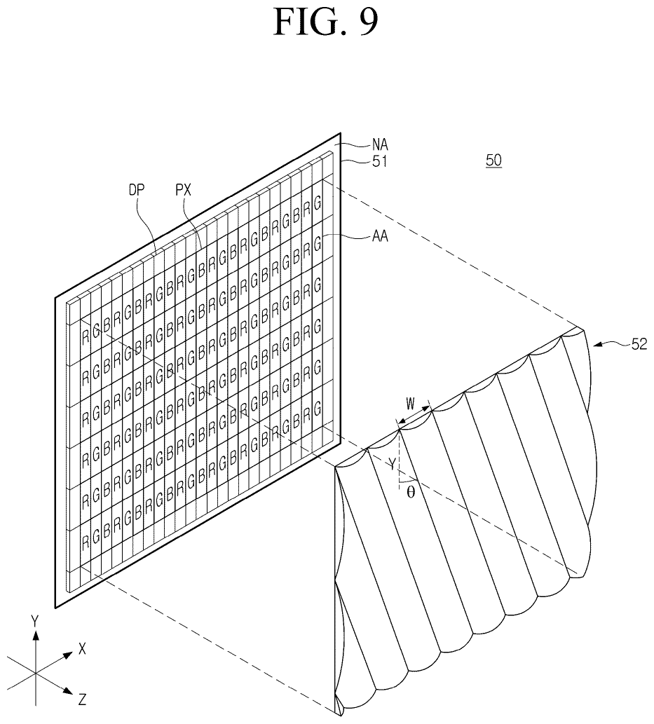

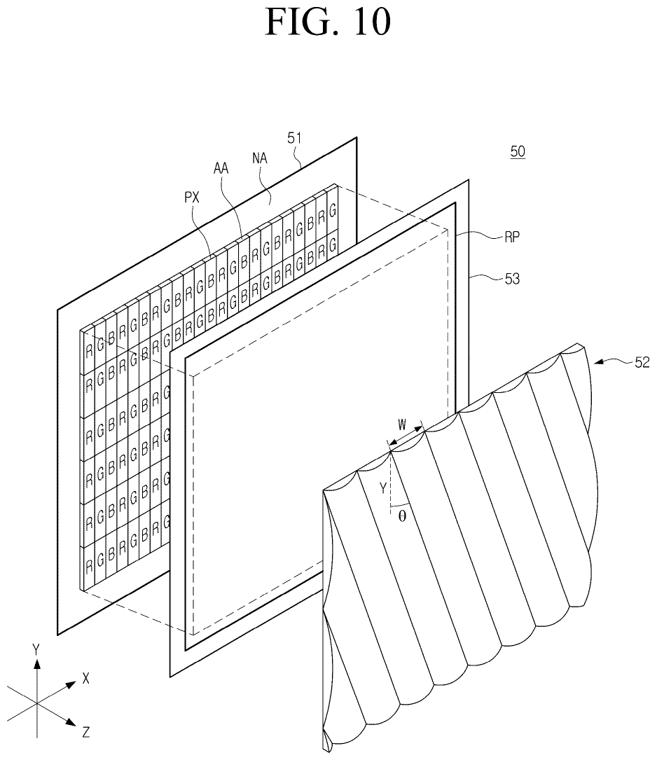

FIG. 8 is a perspective view of a display device according to another embodiment of the present disclosure. FIG. 9 is a schematic exploded perspective view of a display module according to another embodiment of the present disclosure. FIG. 10 is a schematic exploded perspective view of a display module according to yet another embodiment of the present disclosure.

Compared to the embodiments of FIGS. 2 and 3, the display module 50 in the embodiment of FIG. 8 can be configured to display a predefined reference pattern RP. The reference pattern RP can be reflected by a predetermined reflective screen positioned at the front of the display module 50 and captured by a camera or other components constituting the eye-tracking unit 11. The reference pattern RP can be designed such that its mirrored image changes in shape, size, or center position depending on the alignment state, allowing identification of the alignment state between the display module 50 and the camera. For example, the reference pattern RP can be a polygon such as a triangle, square, or rectangle, or a circular shape, but is not limited thereto. The reference pattern RP can be configured to have a symmetrical shape, but is not limited thereto.

Referring to FIG. 9, the display panel 51 can include a plurality of dummy pixels DP for displaying the reference pattern RP. The dummy pixels DP can be arranged in the non-display area NA of the display panel 51. Within the non-display area NA, the dummy pixels DP can be arranged to correspond to the reference pattern RP. For example, the dummy pixels DP can be arranged in a shape corresponding to the reference pattern RP within the non-display area NA. Alternatively, the dummy pixels DP can be arranged in the same matrix form as the pixels PX in the display area AA, with some of the dummy pixels DP controlled to display the reference pattern RP.

In the embodiment of FIG. 9, the reference pattern RP has a rectangular shape surrounding the display area AA. Dummy pixels DP for displaying the reference pattern RP are arranged to surround the display area AA. In this case, one or more rows or columns of dummy pixels can be configured to display each side of the reference pattern RP. In FIG. 9, the sides of the rectangular reference pattern RP are composed of one row or one column of dummy pixels, but the embodiment is not limited to this configuration.

The dummy pixels DP can have the same or different circuit structure compared to the pixels PX arranged in the display area AA. However, the dummy pixels DP are driven to display an image corresponding to the reference pattern RP during the alignment correction process described later, and are not driven to display an image during the display driving process, where images are displayed through the pixels PX of the display area AA.

Referring to FIG. 10, the display module 50 can include a light field film 53 instead of dummy pixels DP. The light field film 53 can include the reference pattern RP at a location corresponding to the non-display area NA of the display panel 51. The reference pattern RP can be printed on the film using methods such as inkjet printing. Alternatively, the light field film 53 can be configured to include dummy pixels DP corresponding to the non-display area NA, similar to the display panel 51.

The light field film 53 can be interposed between the display panel 51 and the lens array 52. The light field film 53 can be deposited on the display panel 51, formed integrally with the display panel 51, or attached to the display panel 51 using an adhesive or other means.

The lens array 52 can be arranged so as not to cover at least a portion of the above-described dummy pixels DP or the reference pattern RP. When the lens array 52 covers the dummy pixels DP or the reference pattern RP, the eye-tracking unit 11 can have errors in recognizing the image reflected by the reflective screen. Accordingly, the lens array 52 can be arranged to leave all or part of the dummy pixels DP and the reference pattern RP exposed. For example, the lens array 52 can be arranged to cover the display area AA. However, the embodiments of the present disclosure are not limited thereto.

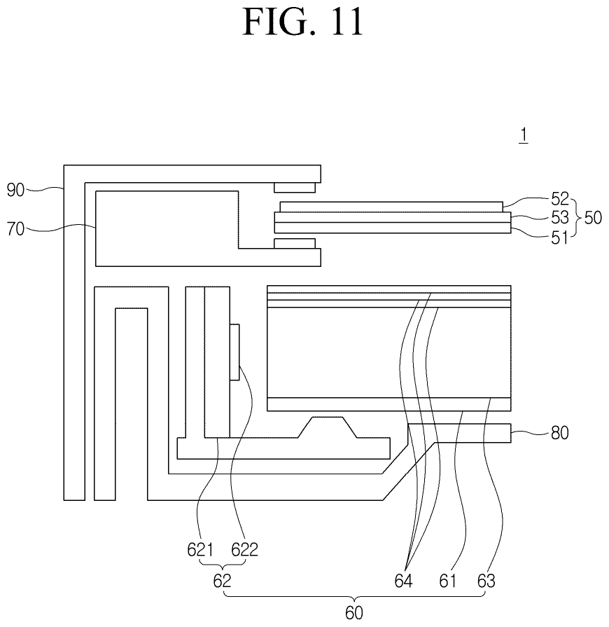

FIG. 11 is a schematic cross-sectional view of a display device according to an embodiment of the present disclosure.

Referring to FIG. 11, a display device 1 according to an embodiment of the present disclosure can include a display module 50, a backlight unit 60, a guide frame 70, a support case 80, and a front case 90.

The display module 50 can include a display panel 51. The display panel 51 can be, for example, a liquid crystal display panel, an organic light-emitting display panel, a plasma display panel (PDP), an electrophoretic display panel, a quantum dot (QD) display panel, a mini LED display panel (mini light-emitting device display panel), or a micro LED display panel (micro light-emitting device display panel). Here, LED can also be a light emitting diode.

When the display panel 51 is a liquid crystal display panel, it can include a lower substrate and an upper substrate that are bonded together with a liquid crystal layer in between. The lower substrate can include a display area and a non-display area. In the display area, the lower substrate can include a plurality of pixels formed in regions where gate lines and data lines intersect. In the non-display area, the lower substrate can include a plurality of dummy pixels formed in regions where gate lines and data lines intersect. In the non-display area, the lower substrate can be arranged to display a predetermined reference pattern.

The pixels and dummy pixels can include, for example, thin-film transistors, pixel electrodes connected to the thin-film transistors, and common electrodes disposed to face the pixel electrodes with the liquid crystal layer in between. Depending on the embodiment, the common electrode can also be formed on the upper substrate.

The upper substrate can include color filters corresponding to each pixel formed on the lower substrate. The upper substrate can be bonded to the lower substrate.

When the display panel 51 is an organic light-emitting display panel, the display panel 51 can include a circuit element layer, in which circuit elements such as thin-film transistors and capacitors are arranged, and an emissive element layer including organic light-emitting elements.

The display panel 51 can include a polarization layer attached to the upper and/or lower surface. In one embodiment of the present disclosure, the polarization layer attached to the upper surface of the display panel 51 can include a lens array 52. The lens array 52 can be, for example, a lenticular lens array, but is not limited thereto. In one embodiment of the present disclosure, the lens array 52 can be formed on the display panel 51 to cover a portion of the display panel 51. For example, the lens array 52 can be formed to cover the display area AA (FIG. 2) of the display panel 51 and can be arranged not to cover a portion of the non-display area NA (FIG. 2). For example, the lens array 52 can be formed not to cover the dummy pixels DP (FIG. 9) formed in the non-display area NA and/or the reference pattern RP (FIG. 10) formed on the light field film 53, which will be described later.

In one embodiment of the present disclosure, instead of the dummy pixels, a light field film 53 can be further disposed on the upper surface of the display panel 51. The light field film 53 can be interposed between the display panel 51 and the lens array 52. In an embodiment of the present disclosure where dummy pixels are arranged on the display panel 51, the light field film 53 can be omitted.

The backlight unit 60 is disposed below the display module 50 and irradiates light onto the entire rear surface of the display module 50. The backlight unit 60 is disposed within the support case 80 and includes a reflection sheet 61 that reflects incident light toward the display module 50, a light-emitting diode module 62 installed on one side of the support case 80 to emit light, a light guide plate 63 seated on the reflection sheet 61 to guide light incident from the light-emitting diode module 62 toward the display module 50, and a plurality of optical sheet members 64 disposed on the light guide plate 63 to enhance the luminance characteristics of light propagating toward the display module 50.

The light-emitting diode module 62 includes an LED array substrate 621 and a plurality of LED packages 622.

The LED array substrate 621 is vertically installed on the support case 80 to face the light incident portion provided on one side of the light guide plate 63. The LED array substrate 621 is formed with a driving power line and other necessary components for emitting each of the plurality of LED packages 622.

Each of the plurality of LED packages 622 is mounted at regular intervals on the LED array substrate 621, emits light when driven by the driving power supplied from the driving power line, and emits light with a predetermined luminance toward the light incident portion of the light guide plate 63.

The light emitted from each of the plurality of LED packages 622 enters the light incident portion of the light guide plate 63, is reflected and refracted inside the light guide plate 63, and, together with the light reflected by the reflection sheet 61, passes through the plurality of optical sheet members 64 to be irradiated onto the display module 50.

The guide frame 70 is formed to support the rear edge portion of the display module 50 and is mounted inside the support case 80.

The support case 80 is coupled to the guide frame 70 to accommodate the backlight unit 60 while also supporting the guide frame 70. The support case 80 includes a support plate that supports the backlight unit 60 and a support sidewall that extends vertically from the support plate and is bent at least once to support the guide frame 70. Here, the inner wall of the support sidewall is provided with an adhesive member that attaches the LED array substrate 621 of the light-emitting diode module 62.

The front case 90 is formed to have an “L”-shaped cross-section and is coupled to the side of the support case 80, thereby enclosing the front edge portion of the display module 50 as well as the guide frame 70 and the side of the support case 80.

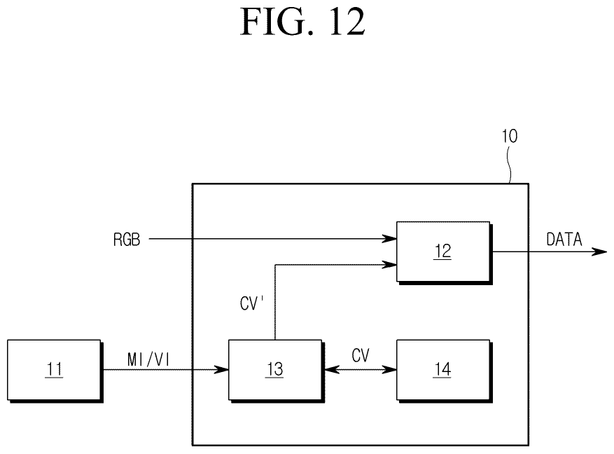

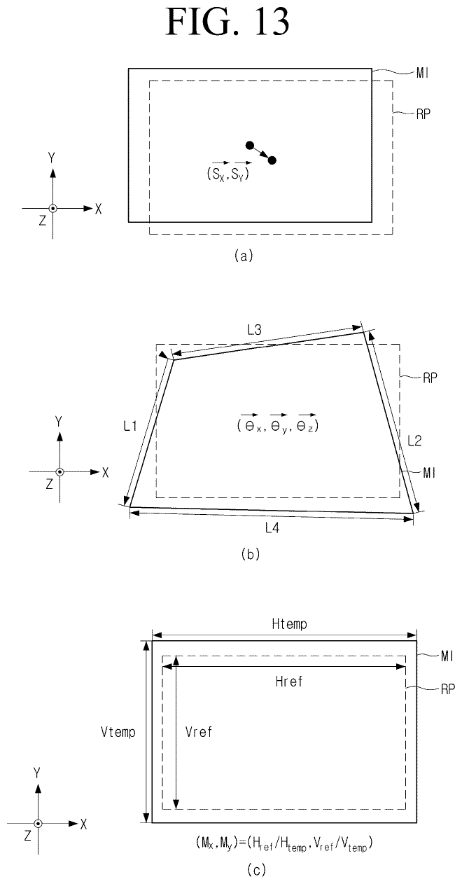

FIG. 12 is a block diagram illustrating the configuration of a control unit according to an embodiment of the present disclosure. FIG. 13 is a diagram illustrating a method of correcting an image based on reflected images obtained through the eye-tracking unit.

Referring to FIGS. 8 to 10 and 12, the control unit 10 according to one embodiment of the present disclosure can include an image data generation unit 12, a compensation unit 13, and a memory 14.

The image data generation unit 12 is configured to convert a video signal RGB received from an external source according to the characteristics of the display panel 51 to generate image data DATA and transmit the image data DATA to the data driver 30 (FIG. 1). For example, the image data generation unit 12 can arrange a 3D image signal according to a predetermined view map suitable for left-eye and right-eye images and transmit it to the data driver 30.

In one embodiment of the present disclosure, the image data generation unit 12 can drive some or all of the dummy pixels DP arranged in the non-display area NA of the display panel 50 (FIG. 1) to control the display of the reference pattern RP. For example, the image data generation unit 12 can apply image data DATA corresponding to a predetermined luminance to the dummy pixels DP and apply a scan signal generated through a separate control signal generation unit, thereby controlling the dummy pixels DP to emit light.

While the reference pattern RP is displayed, a predetermined reflective screen can be arranged in front of the display module 50. The reflected image MI of the display module 50 projected onto the reflective screen can be captured through the eye-tracking unit 11. The reflected image MI captured by the eye-tracking unit 11 can include a reflected image of the reference pattern RP.

The compensation unit 13 can determine whether a misalignment (parallax) has occurred between the camera and the display module 50 based on the reflected image MI captured by the eye-tracking unit 11. When a misalignment is determined, the compensation unit 13 can calculate a compensation value to correct the subsequent images captured by the eye-tracking unit 11 based on the misaligned state.

Depending on the alignment status between the camera constituting the eye-tracking unit 11 and the display module 50, the reflected image MI of the reference pattern RP can have different shapes, sizes, and centroids. For example, when the camera's shooting direction and the normal of the display module 50 are aligned according to a preset alignment relationship, as shown in FIG. 13, the reference pattern RP in the reflected image MI can be captured in a rectangular (reference) shape. In this case, the reference pattern RP in the reflected image MI can have a predetermined reference size, and the centroid O of the reference pattern RP can be located at a predetermined reference position.

Referring to (a) of FIG. 13, when the camera and the display module 50 are misaligned in the vertical direction Y and/or horizontal direction X, the centroid O of the reference pattern RP in the reflected image MI can shift from the reference position to a different location.

Specifically, when the camera and the display module 50 are misaligned (shifted) in the vertical direction Y, the reference pattern RP in the reflected image MI can have its centroid O move in the vertical direction Y. When the camera and the display module 50 are misaligned (shifted) in the horizontal direction (X), the reference pattern RP in the reflected image MI can have its centroid O move in the horizontal direction (X). In this case, the direction of the movement of the centroid O is opposite to the direction of the camera shift, and the distance of the movement corresponds to the degree of camera shift.

When the centroid O of the reference pattern RP in the reflected image MI has shifted from the reference position to a different location, the compensation unit 13 can calculate a shift compensation value to move the shifted centroid O′ to the reference centroid O position. The shift compensation value can be defined as a vector ( [symbol] , [symbol] ) from the shifted centroid O′ to the reference centroid O. The vector ( [symbol] , [symbol] ) can include horizontal direction component ( [symbol] ) and vertical direction component ( [symbol] ). The magnitude of each component is determined based on the degree of the camera shift, and the direction of each component can be determined opposite to the direction of the camera shift.

Referring to (b) of FIG. 13, when the camera's shooting direction is misaligned with the front of the display module 50, or when the camera itself is tilted horizontally, the shape of the reference pattern RP in the reflected image MI can change (i.e., tilt). For example, when a misalignment occurs, the reference pattern RP in the reflected image MI can be an arbitrary quadrilateral, such as a trapezoid or a rhombus, rather than a rectangle.

Specifically, when the camera's shooting direction is rotated about the vertical direction Y axis relative to the reference shooting direction (i.e., when the camera is rotated in the horizontal direction X), the side L1 of the reference pattern RP in the reflected image MI, placed in the rotated direction, can be shorter than the side L2 of the reference pattern RP placed in the opposite direction of the rotation. Further, when the camera's shooting direction is rotated about the horizontal direction Z axis relative to the reference shooting direction (i.e., when the camera is rotated in the vertical direction Y), the side L3 of the reference pattern RP in the reflected image MI, placed in the rotated direction, can be shorter than the side L4 of the reference pattern RP in the opposite direction of the rotation. In this case, the difference in the lengths between the two opposing sides (L1, L2 and L3, L4) can correspond (be proportional) to the degree of rotation of the camera, and the direction of the camera's rotation can be determined by the direction in which the shorter side is positioned. Therefore, based on the difference in the lengths of the sides (L1, L2, L3, L4) of the reference pattern RP in the reflected image MI, the rotation angle and direction of the camera relative to the horizontal direction X and vertical direction Y axes can be determined.

When the camera's shooting direction is rotated about the front-back direction Z axis (i.e., when the camera itself is tilted horizontally), the reference pattern RP in the reflected image MI can tilt in the opposite direction of the camera's tilt. Thus, based on the tilted angle and direction of the reference pattern RP in the reflected image MI, the rotation angle and direction of the camera relative to the front-back direction Z axis can be determined.

When the shape of the reference pattern RP in the reflected image MI changes (i.e., when the reference pattern RP is tilted), the compensation unit 13 can calculate a rotation compensation value to correct the reflected reference pattern RP's shape back to the original reference pattern RP's shape. The rotation compensation value can be defined as a rotation vector ( [symbol] , [symbol] , [symbol] ) to convert the rotated reference pattern RP to the original reference pattern RP. The rotation vector ( [symbol] , [symbol] , [symbol] ) can include the rotation components about the horizontal direction X axis ( [symbol] ), the vertical direction Y axis ( [symbol] ), and the front-back direction Z axis ( [symbol] ). The magnitude of each component is determined based on the degree of camera rotation (the rotated angle), and the direction of each component can be determined opposite to the direction of the camera's rotation.

Referring to (c) of FIG. 13, when the camera and the display module 50 are misaligned in the front-back direction Z, the size of the reference pattern RP in the reflected image MI can change.

Specifically, when the camera moves closer to the front of the display module 50, the size of the reference pattern RP in the reflected image MI increases, and when the camera moves farther from the front of the display module 50, the size of the reference pattern RP in the reflected image decreases. In this case, the difference between the original size of the reference pattern RP and the changed size can correspond (be proportional) to the degree of camera shift.

When the size of the reference pattern RP in the reflected image MI changes, the compensation unit 13 can calculate a scale compensation value to correct the changed size of the reference pattern RP to the original size. The scale compensation value can be defined as a scale coefficient, which is the ratio of the original size to the changed size. The scale coefficient can include, for example, a horizontal scale coefficient (Mx) and a vertical scale coefficient (My). The horizontal scale coefficient (Mx) can be determined as the ratio of the changed horizontal length Htemp of the reference pattern RP to the original horizontal length Href, i.e., Href/Htemp, and the vertical scale coefficient (My) can be determined as the ratio of the changed vertical length Vtemp of the reference pattern RP to the original vertical length Vref, i.e., Vref/Vtemp.

The compensation unit 13 can store the determined compensation values CV, such as the shift compensation value, rotation compensation value, and scale compensation value, in memory 14 or the like. During the display driving, where image data DATA is applied to the pixels PX arranged in the display area AA of the display panel 51 via the image data generation unit 12 and the pixels emit light in response to the image data DATA, the compensation unit 13 can acquire the viewer's image VI through the eye-tracking unit 11. The compensation unit 13 can then correct the acquired viewer image VI according to the stored compensation values CV in memory 14 or the like. That is, the compensation unit 13 can shift the acquired viewer image VI according to the shift compensation value, rotate it according to the rotation compensation value, and scale it (enlarge or reduce) according to the scale compensation value.

The corrected viewer image CV′ is generated by compensating for the misalignment between the camera constituting the eye-tracking unit 11 and the display module 50, allowing the viewer's more accurate position to be determined through the corrected viewer image CV′ even when the camera is misaligned.

The corrected image CV′ from the compensation unit 13 can be transmitted to the image data generator 12. The image data generator 12, based on the corrected image obtained from the compensation unit 13, determines the viewer's position, arranges the image data DATA according to the view map corresponding to the viewer's position, and transmits it to the data driver 30.

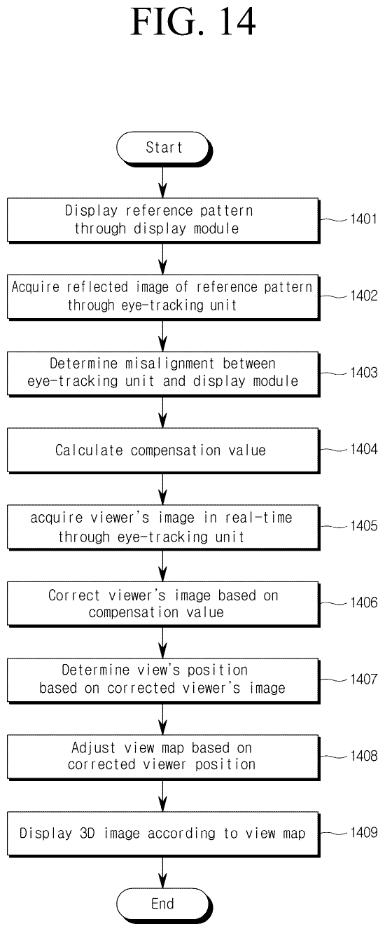

FIG. 14 is a flowchart illustrating a method for driving a display device according to an embodiment of the present disclosure.

Referring to FIG. 14, the display device according to one embodiment of the present disclosure can perform a driving operation to determine a misalignment between the eye-tracking unit 11 and the display module 50.

To this end, the display device can display a reference pattern through the display module in operation 1401. For example, the reference pattern can be displayed through a light field film or by dummy pixels arranged in the non-display area of the display panel.

Then, a reflected image, reflected on a reflective screen located in front of the display module 50, can be acquired through the eye-tracking unit 11 in operation 1402. The reflected image acquired through the eye-tracking unit 11 can include the reflected image (reflected pattern, mirroring image) of the reference pattern.

In operation 1403, the display device can determine a misalignment between the eye-tracking unit 11 and the display module 50 based on the acquired reflected image. For example, the display device can determine a misalignment by comparing the actual reflected image captured with the preset reference reflected image, which is the expected reflected image when the eye-tracking unit 11 and the display module 50 are correctly aligned.

When the misalignment is determined, the display device can calculate a compensation value based on the reflected pattern in operation 1404. The compensation value is intended to make the captured reflected image match the expected reflected image of the reference pattern and can include shift compensation, rotation compensation, and scale compensation values.

When no misalignment is determined, the display device can skip the compensation value calculation process or set the compensation value to a predetermined default value.

Subsequently, the display device can perform a display driving operation to provide 3D images to the viewer.

To this end, the display device can acquire the viewer's image in real-time through the eye-tracking unit 11 in operation 1405. The display device can then correct the viewer's image based on the previously determined compensation values in operation 1406. When no misalignment is determined, the viewer's image may not be corrected.

The display device can determine the viewer's position based on the corrected image in operation 1407, adjust the view map according to the determined viewer position in operation 1408, and display the 3D image in operation 1409.

As described above, the three-dimensional image display device and the method for driving the same according to the embodiments of the present disclosure are advantageous for correcting alignment errors between a camera that detects a user's position and a display panel in a glasses-free three-dimensional image display device.

The three-dimensional image display device and the method for driving the same according to the embodiments of the present disclosure are also advantageous for improving the quality of the three-dimensional image by preventing degradation in viewing angle and resolution caused by a misalignment between the camera and the display panel.

The three-dimensional image display device and the method for driving the same according to the embodiments of the present disclosure are also advantageous for enhancing the resolution and viewing angle of the three-dimensional image by utilizing eye-tracking.

Although embodiments of this disclosure have been described above with reference to the accompanying drawings, it will be understood that the technical configuration of this disclosure described above can be implemented in other specific forms by those skilled in the art without changing the technical concept or essential features of the present disclosure. Therefore, it should be understood that the embodiments described above are examples and not limited in all respects. Furthermore, the scope of the present disclosure is defined by the claims set forth below, rather than the detailed description above. In addition, it should be understood that all modifications or variations derived from the meaning and scope of the claims and their equivalent concept are included within the scope of the disclosure.

What is claimed is:

1. A three-dimensional image display device comprising:
an eye-tracking unit configured to capture a viewer image;
a control unit configured to convert an externally input image signal into image data, identify a viewer's position relative to a display module based on the viewer image, and align and output the image data based on a view map corresponding to the viewer's position;
a data driver configured to convert the image data output from the control unit into a data voltage and output the data voltage; and
the display module configured to display a three-dimensional image based on the data voltage,
wherein the display module comprises:
a display panel having a display area in which pixels are arranged and a non-display area adjacent to the display area; and
a lens array disposed on the display panel, and
wherein the display module is configured to display a reference pattern in the non-display area to determine a misalignment between the eye-tracking unit and the display module.

2. The three-dimensional image display device of claim 1, wherein the lens array is disposed so as to not cover at least a portion of the reference pattern.

3. The three-dimensional image display device of claim 1, wherein the display panel comprises:
the pixels disposed in the display area and configured to display the three-dimensional image; and
dummy pixels disposed in the non-display area and configured to display the reference pattern.

4. The three-dimensional image display device of claim 1, wherein the display module further comprises a light field film interposed between the display panel and the lens array, the light field film having the reference pattern formed at a position corresponding to the non-display area.

5. The three-dimensional image display device of claim 1, wherein the reference pattern includes a square shape or a rectangle shape.

6. The three-dimensional image display device of claim 1, wherein the eye-tracking unit is configured to capture a reflected image by capturing a reflective screen disposed in front of the display module while the display module displays the reference pattern, the reflected image including a reflected image of the reference pattern.

7. The three-dimensional image display device of claim 6, wherein the control unit comprises:
a compensation unit configured to determine whether a misalignment exists between the eye-tracking unit and the display module based on the reflected image of the reference pattern, calculate a compensation value to correct the misalignment, and correct and output the viewer image acquired from the eye-tracking unit based on the compensation value.

8. The three-dimensional image display device of claim 7, wherein the control unit further comprises:
an image data generation unit configured to identify the viewer's position based on the corrected viewer image output from the compensation unit and align and output the image data based on the view map corresponding to the viewer's position.

9. The three-dimensional image display device of claim 7, wherein the control unit further comprises a memory configured to store the compensation value.

10. The three-dimensional image display device of claim 7, wherein the compensation unit is configured to calculate a shift compensation value to shift the reflected image to match a preset reference reflected image based on the reflected image being displaced in a horizontal or vertical direction relative to the preset reference reflected image.

11. The three-dimensional image display device of claim 10, wherein the compensation unit is further configured to calculate a rotation compensation value to rotate the reflected image to match the preset reference reflected image based on the reflected image being tilted relative to the preset reference reflected image.

12. The three-dimensional image display device of claim 11, wherein the compensation unit is further configured to calculate a scale compensation value to enlarge or reduce the reflected image to match the preset reference reflected image in size based on the reflected image differing in size from the preset reference reflected image.

13. The three-dimensional image display device of claim 7, wherein the display panel comprises:
the pixels disposed in the display area and configured to display the three-dimensional image; and
dummy pixels disposed in the non-display area and configured to display the reference pattern, and
wherein the image data generation unit is configured to transmit image data to the dummy pixels to display the reference pattern.

14. The three-dimensional image display device of claim 1, wherein the eye-tracking unit comprises a camera mounted on one side of the display module or within the display module.

15. A method of driving a three-dimensional image display device including a camera configured to capture an image, and a display module including a display panel having a display area in which pixels are arranged and a non-display area adjacent to the display area, and a lens array disposed on the display panel, the display module being configured to display a reference pattern, the method comprising:
capturing a reflected image disposed in front of the display module through the camera while the display module displays the reference pattern;
determining a misalignment between the camera and the display module based on a reflected image of the reference pattern included in the reflected image;
calculating a compensation value to correct the misalignment;
capturing a viewer image through the camera;
correcting the viewer image based on the compensation value;
identifying a viewer's position relative to the display module based on the corrected viewer image; and
aligning and displaying image data of a three-dimensional image according to a predefined view map corresponding to the viewer's position.

16. The method of claim 15, wherein the display panel comprises:
the pixels disposed in the display area and configured to display the three-dimensional image; and
dummy pixels disposed in the non-display area and configured to display the reference pattern,
the method further comprising, prior to capturing the reflected image, controlling the dummy pixels to display the reference pattern.

17. The method of claim 15, wherein the display panel further comprises a light field film interposed between the display panel and the lens array, the light field film having the reference pattern formed at a position corresponding to the non-display area.

18. The method of claim 15, wherein the determining of the misalignment comprises:
determining whether the reflected image matches a preset reference reflected image predefined for the reference pattern.

19. The method of claim 15, wherein the calculating of the compensation value comprises:
calculating a shift compensation value to shift the reflected image to match a preset reference reflected image based on the reflected image being displaced in a horizontal or vertical direction relative to the preset reference reflected image.

20. The method of claim 19, wherein the calculating of the compensation value further comprises:
calculating a rotation compensation value to rotate the reflected image to match the preset reference reflected image based on the reflected image being tilted relative to the preset reference reflected image; and
calculating a scale compensation value to enlarge or reduce the reflected image to match the preset reference reflected image in size based on the reflected image differing in size from the preset reference reflected image.
